(19) United States
(12) Patent Application Publication
(10) Pub. No.: US 2012/0086804 A1
(43) Pub. Date: Apr. 12, 2012

(54) IMAGING APPARATUS AND METHOD OF CONTROLLING THE SAME

(75) Inventors: Yoshihito Ishibashi, Tokyo (JP); Shigeru Tajima, Kanagawa (JP); Daisuke Yamazaki, Kanagawa (JP); Masahiro Suzuki, Kanagawa (JP)

(73) Assignee: SONY CORPORATION, Tokyo (JP)

(21) Appl. No.: 13/086,908

(22) Filed: Apr. 14, 2011

(30) Foreign Application Priority Data
Apr. 19, 2010 (JP) P2010-095846

(51) Int. Cl. H04N 7/18

(52) U.S. Cl. 348/143; 348/E07.085

(57) ABSTRACT

There is provided an imaging apparatus including a power generation unit which converts natural energy into electric energy and generates electric power, an imaging unit which captures a subject image and generates imaging data, a memory which stores the imaging data, a radio communication unit which transmits the imaging data stored in the memory, a control unit which controls operation of the imaging unit and of the radio communication unit, and a battery which is charged with the generated electric energy and supplies electric power to the imaging unit, the memory, the radio communication unit, and the control unit, where the control unit estimates a charge amount of the battery in the future based on average power generation of the power generation unit and changes operation of the imaging unit or of the radio communication unit, based on the charge amount in the future.

### CROSS REFERENCES TO RELATED APPLICATIONS

The present application claims priority to Japanese Priority Patent Application JP 2010-095846 filed with the Japan Patent Office on Apr. 19, 2010, the entire content of which is hereby incorporated by reference.

### BACKGROUND

The present application relates to an imaging apparatus and a method of controlling the same.

A monitoring camera is placed at a point away from a location where an observer performs monitoring. The monitoring camera generally receives electric power, through a power line, from a power transmission and distribution system which constantly supplies electric power. Further, also when the monitoring camera had a built-in battery and used the same, the monitoring camera could continuously operate regardless of a remaining amount of electric power of the battery, because electric power was constantly supplied.

In JP 2006-50243A, a technique is disclosed in which a radio communication apparatus, to which electric power is supplied exclusively from a battery, moves into a power-saving state in order to save electric power, in accordance with its surrounding brightness. Further, in JP 2008-167047A, a technique is disclosed in which, in an imaging apparatus powered by a solar battery and a storage battery, a remaining amount of electric power is calculated according to weather information and between shooting modes is switched based the remaining amount of electric power.

### SUMMARY

It is difficult to supply electric power to a monitoring camera in an area where, especially, a power transmission and distribution system is not well organized. For example, it is often difficult to supply electric power to, for example, a camera that monitors overhunting of animals deep in a jungle or a camera that performs monitoring operation in a battlefield. Accordingly, a camera unit in which a solar battery and a battery (including a capacitor as well, hereinafter) and a camera are combined is sought.

However, in case of using the above camera unit as a monitoring camera, electric power of the solar battery was generated only in the daytime and a limited amount of electric power was stored in the battery. Accordingly, there was an issue that there occurred a shortage of electric power when power consumption was not appropriately controlled. Further, it is assumed that weather information or the like is acquired via a communication line such as a network in order to accurately estimate power generation of the solar battery in the future. However, there was an issue that it was difficult to estimate the power generation of the solar battery in the future, when no information could be acquired from the communication line.

In light of the foregoing, it is desirable to provide an imaging apparatus and a method of controlling the same, which are novel and improved, and which are capable of continuously performing imaging for a long duration, without acquiring information from a communication line, regardless of a variation in a generation amount of electric power or in a charge amount.

According to an embodiment, there is provided an imaging apparatus including a power generation unit which converts natural energy into electric energy and generates electric power, an imaging unit which captures a subject image and generates imaging data, a memory which stores the imaging data, a radio communication unit which transmits the imaging data stored in the memory, a control unit which controls operation of the imaging unit and of the radio communication unit, and a battery which is charged with the generated electric energy and supplies electric power to the imaging unit, the memory, the radio communication unit, and the control unit, where the control unit estimates a charge amount of the battery in the future based on average power generation of the power generation unit and changes operation of the imaging unit or of the radio communication unit, based on the charge amount in the future.

The control unit may calculate a remaining amount of memory of the memory and may calculate a remaining amount of electric power of the battery and may change operation of the imaging unit or of the radio communication unit, based on the remaining amount of memory and the remaining amount of electric power, which were calculated.

The control unit may change operation of the imaging unit by controlling image quality of the imaging data, a compression rate of the imaging data, and imaging frequency or an imaging range of the imaging unit.

The control unit may change operation of the radio communication unit by controlling transmission frequency of the imaging data.

The control unit may cause the radio communication unit to receive imaging data from an external imaging apparatus and to transmit the received imaging data to another external imaging apparatus, based on the charge amount in the future.

According to another embodiment, there is provided a method of controlling an imaging apparatus, including the steps of converting by a power generation unit natural energy into electric energy and generating by the power generation unit electric power, capturing by an imaging unit a subject image and generating by the imaging unit imaging data, storing by a memory the imaging data, transmitting by a radio communication unit the imaging data stored in the memory, controlling by a control unit operation of the imaging unit and of the radio communication unit, charging by a battery the generated electric energy and supplying by the battery electric power to the imaging unit, the memory, the radio communication unit, and the control unit, and estimating by the control unit a charge amount of the battery in the future based on average power generation of the power generation unit and changing by the control unit operation of the imaging unit or of the radio communication unit, based on the charge amount in the future.

According to the embodiments of the present application described above, it is possible to perform imaging for a long duration, without acquiring information from a communication line, regardless of a variation in a generation amount of electric power or in a charge amount.

Additional features and advantages are described herein, and will be apparent from the following Detailed Description and the figures.

### BRIEF DESCRIPTION OF THE FIGURES

FIG. 1 is an explanatory diagram illustrating an example of a communication network in which a monitoring camera unit 100 according to an embodiment is arranged;

FIG. 2 is a block diagram illustrating the monitoring camera unit 100 according to the embodiment;

FIG. 3 is a block diagram illustrating a control unit 110 of the monitoring camera unit 100 according to the embodiment;

FIG. 4 is a flow chart illustrating imaging process and data transfer process of the monitoring camera unit 100 according to the embodiment;

FIG. 5 is a flow chart illustrating imaging planning process and data transfer planning process of the monitoring camera unit 100 according to the embodiment;

FIG. 6 is a graph illustrating a variation in a charge amount over time;

FIG. 7 is a table illustrating an example of a method of deciding on an image plan; and

FIG. 8 is a table illustrating an example of a method of deciding on a data transfer plan.

### DETAILED DESCRIPTION

Embodiments of the present application will be described below in detail with reference to the drawings.

Explanation will be made in the following order.

1. Configuration according to an embodiment

2. Operation according to an embodiment

1. Configuration According to an Embodiment

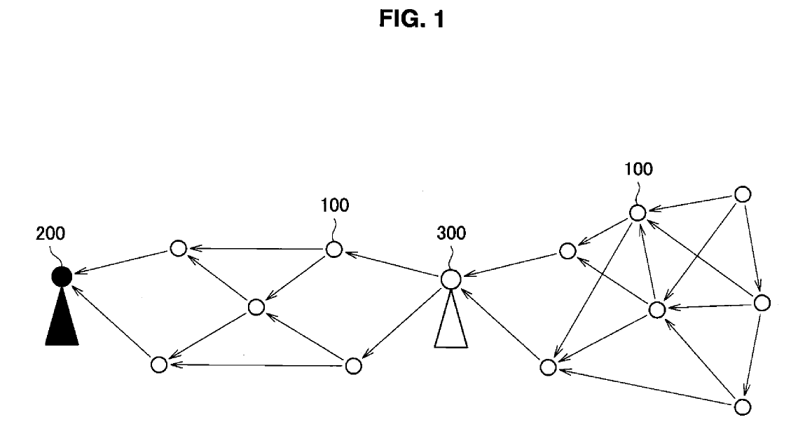

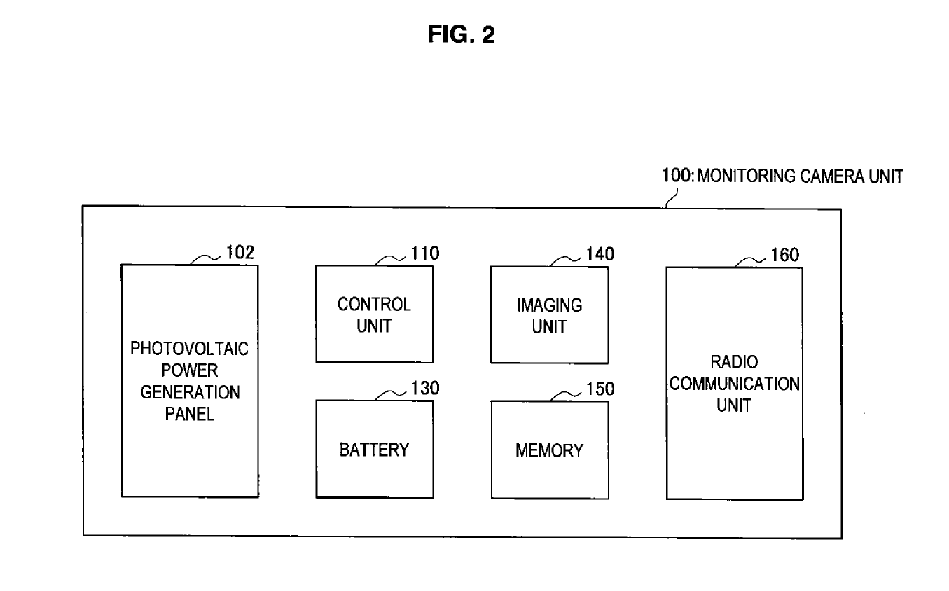

A configuration of a monitoring camera unit 100 according to an embodiment will be explained. FIG. 1 is an explanatory diagram illustrating an example of a communication network in which the monitoring camera unit 100 according to the present embodiment is arranged. FIG. 2 is a block diagram illustrating the monitoring camera unit 100 according to the present embodiment.

As shown in FIG. 1, monitoring camera units 100 constitute together with a server device 200 and a relay unit 300 a communication network. Further, as shown in FIG. 2, a monitoring camera unit 100 includes a photovoltaic power generation panel 102, a control unit 110, a battery 130, an imaging unit 140, a memory 150, a radio communication unit 160, for example. The monitoring camera unit 100 is an example of an imaging apparatus.

The monitoring camera unit 100 is appropriately placed in a space. The monitoring camera unit 100 is placed, for example, in an area in which a power transmission and distribution system is not well organized. A plurality of the monitoring camera units 100 to be placed may have all the same configuration, or may vary in an amount of memory, or in the number of photovoltaic power generation panels, or in the area of a photovoltaic power generation panel. Further, output of the radio communication unit 160 of a monitoring camera unit 100 may be changed according to a positional relationship with another monitoring camera unit 100. For example, when it is far away from such other monitoring camera unit 100, radio receiving sensitivity (gain) of the corresponding radio communication unit 160 is increased and radio power-output is increased; when it is close to such other monitoring camera unit 100, the sensitivity is decreased and the output is decreased. Thereby, optimal electric power regulation can be carried out. As just described, monitoring camera units 100 may have the same basic configuration, but the details may be changed appropriately.

A monitoring camera unit 110 captures a subject image such as surrounding environment and generates imaging data. All imaging data generated by a plurality of the monitoring camera units 110 is transmitted to the server device 200 in the end. Besides, the server device 200 is stably provided with a power source, and has a radio receiver which receives imaging data. The server device 200 manages the received imaging data or displays the imaging data on a display.

Some monitoring camera units 100 are placed relatively far away from the server device 200 and others are placed relatively close to the server device 200. Further, not all monitoring camera units 100 can directly transmit imaging data to the server device 200, because the transmission is carried out in accordance with the communications capacity in radio communication.

Accordingly, a monitoring camera unit 100 placed far away from the server device 200 (hereafter, a first monitoring camera unit 100), transmits imaging data to a monitoring camera unit 100 which is placed around the first monitoring unit 100 and is closer to the server device 200 in comparison with the first monitoring camera unit 100 (hereafter, a second monitoring camera unit 100), or the relay unit 300. The second monitoring camera unit 100, which has received the imaging data, transmits then the imaging data received from the first monitoring camera unit 100 and imaging data generated by the second monitoring camera unit 100 to a monitoring camera unit 100 which is closer to the server device 200 (a third monitoring camera unit 100), the relay unit 200, or the server device 200.

By sequentially transmitting or receiving imaging data as described above, imaging data generated by a plurality of the monitoring camera units 110 can be transferred to the server device 200.

The relay unit 300 is provided with a radio communication unit, and receives imaging data from a monitoring camera unit 100 or transmits imaging data to a monitoring camera unit 100 or the server unit 200. It is desirable that the relay unit 300 has a large-storage battery, a power generation unit which can generates a large amount of electric power, and a large-capacity memory, in comparison with those of a single monitoring camera unit 100. Thereby, the relay unit 300 can process a large amount of imaging data received from a plurality of the monitoring camera units 110.

The photovoltaic power generation panel 102 converts light into electric energy and generates electric power, and transmits the generated electric power to the battery 130. The photovoltaic power generation panel 102 is an example of a power generation unit. The power generation unit according to an embodiment may any one which converts natural energy into electric energy. Besides, the present application achieves its advantages when a power generation unit which unstably generates electric power is applied to an imaging unit. Namely, this is because later-described control, which is characteristic of the present application, does not have to be performed on a power generation unit which can stably generate electric power.

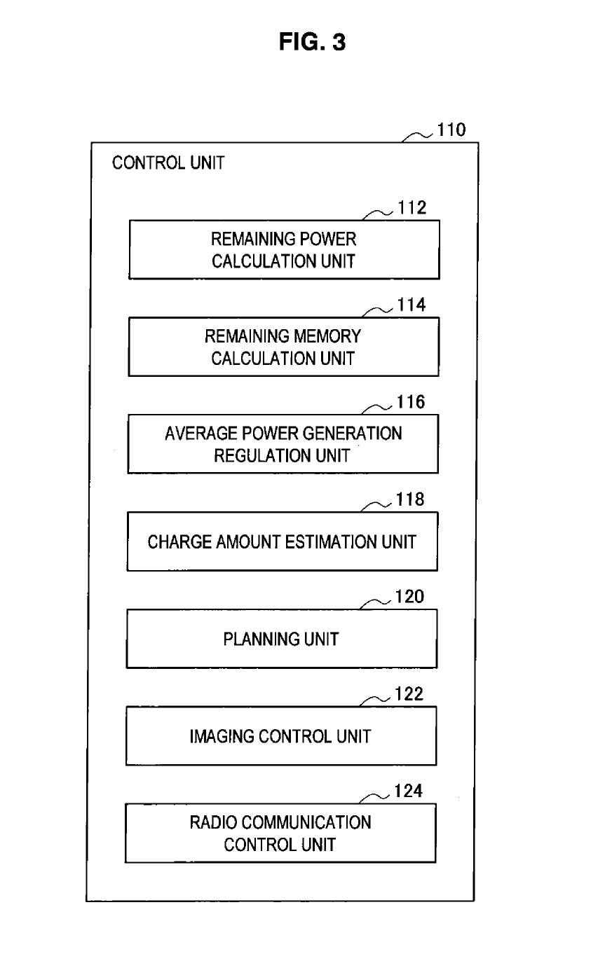

The control unit 110 is, for example, a Central Processing Unit (CPU), and controls components provided in each monitoring camera unit 100. The control unit 110 includes, as shown in FIG. 3, a remaining power calculation unit 112, a remaining memory calculation unit 114, an average power generation regulation unit 116, a charge amount estimation unit 118, a planning unit 120, an imaging control unit 122, and a radio communication control unit 124, for example. FIG. 3 is a block diagram illustrating the control unit 110 of the monitoring camera unit 100 according to the present embodiment.

The remaining power calculation unit 112 measures a current voltage or a discharge amount, which has been accumulated, of the battery 130, and calculates a remaining amount of electric power of the battery. The remaining power calculation unit 112 transmits the remaining amount of electric power, which it calculated, to the planning unit 120.

The remaining memory calculation unit 114 calculates a currently remaining amount of memory of the memory 150. The remaining memory calculation unit 114 transmits the remaining amount, which it calculated, to the planning unit 120.

The average power generation regulation unit 116 acquires power generation data such as an actual amount of electric power generated by the photovoltaic power generation panel 102 and a generation amount of electric power calculated from sunshine duration data and regulates average power generation in units of days or hours, based on the power generation data. The average power generation regulation unit 116 transmits the obtained average power generation to the charge amount estimation unit 118.

Further, the charge amount estimation unit 118 calculates a charge amount in the future, based on the average power generation. For example, the charge amount estimation unit 118 calculates in advance how much electric power will be generated by photovoltaic power generation between X o'clock and Y o'clock. When wind power generation is used in the present application, the charge amount estimation unit 110 calculates in advance how much electric power will be generated per unit hour, for example. The power generation per unit hour may vary according to time. In the charge amount estimation according to the present embodiment, even if weather information cannot be externally received and no weather information is available, a charge amount in the future can be calculated because the average power generation is used.

The planning unit 120 creates an imaging plan or a data transfer plan, by acquiring the estimated charge amount in the future from the charge amount estimation unit 118 and comparing a currently remaining amount of electric power of the battery 130 with a remaining amount of memory of the memory 150.

When it is expected that, for example, remaining electric power of the battery 130 will run short in a few days and remaining memory of the memory 150 will run shout, the planning unit 120 communicates with, for example, a monitoring camera unit 100 in the surroundings while electric power still remains, and creates a data transfer plan such as performing transfer of imaging data. Here, all imaging data stored in the memory 150 does not have to be transferred. For example, imaging data may be transmitted in such a manner that a minimum amount of memory necessary for imaging data to be recorded therein until the next power generation can be secured.

When electric power enough to enable imaging data to be transferred remains, the planning unit 120 creates an imaging plan such as changing an imaging condition, because remaining electric power needs to be saved until electric power can be generated next. For example, when 360 degree imaging is performed by, for example, expanding an imaging time interval, degrading the image quality, and rotating an optical system of the imaging unit 140, an imaging plan such as expanding a rotation angle interval is created. Thereby, it is possible to reduce an amount of data to be used for saving imaging data.

Besides, it may be that a sensor is provided to recognize the brightness and an imaging plan and a data transfer plan is created. However, the photovoltaic power generation panel 102 is provided in the present embodiment, and the brightness can be estimated from an amount of electric power which has been actually generated. However, though the current brightness can be recognized, the brightness in the future (for example, after several hours) cannot be estimated. For this reason, fewer advantages will be obtained by providing a sensor to recognize the brightness and creating an imaging plan and a data transfer plan based on the brightness than in the present embodiment.

The imaging control unit 122 controls the imaging unit 140 in such a manner that imaging is performed based on an imaging plan.

The radio communication control unit 124 controls the radio communication unit 160 in such a manner that data transfer is performed based on a data transfer plan.

The battery 130 is charged with electric power which was generated by the photovoltaic power generation panel 102. The battery 130 supplies electric power to all circuits provided in the monitoring camera unit 100. For example, the control unit 110, the imaging unit 140, the radio communication unit 160, and the like operate by receiving power supply from the battery 130.

The imaging unit 140 includes an optical system such as lens, an imaging device such as a CCD image sensor and a CMOS sensor, an image processing circuit, and the like. As the imaging unit 140, any one by which 360 degree imaging can be performed may be used. In order to realize 360 degree imaging, the imaging unit 140 may perform imaging by rotating an optical system such as lens and a mirror, or may use a mirror of an optical system, by which a 360 degree shot of a subject can be obtained by a single shooting.

Imaging by the imaging unit 140 may be regularly performed based on an imaging plan, but it may be also that a motion sensor, a vibration sensor, or the like is provided in a monitoring camera unit 100 and imaging is performed only when there is a moving object in proximity to the monitoring camera unit 100.

The imaging unit 140 generates imaging data. The imaging data includes, at least, an unit ID according which a monitoring camera unit 100 is identified, imaging time, and image data. Besides, when the monitoring camera unit 100 can move, location information obtained by the use of a Global Positioning System (GPS), or the like, may be included in the imaging data. The image quality of imaging data generated by the imaging unit 140, a compression rate, an imaging time interval, at which the imaging unit 140 captures an image, and an imaging range, in which the imaging unit 140 captures an image, comply with instructions from the control unit 110. If 360 degree imaging is possible, the imaging range is determined, for example, according to at every what degree to capture an image. The generated imaging data is transferred to the memory 150 and is saved.

The memory 150 stores various types of data, for example, imaging data. The memory 150 is a nonvolatile memory and is, for example, a HDD, or a flash memory.

The radio communication unit 160 transmits imaging data to another monitoring camera unit 110, the server device 200, or the relay unit 300, or receives imaging data from another monitoring camera unit 110, the server device 200, or the relay unit 300. An amount of imaging data to be transferred by the radio communication unit 160 complies with an instruction from the control unit 110. Besides, the communication method of the monitoring camera unit 100 according to an embodiment is limited to radio communication. If wired communication is possible in the monitoring camera unit 100, stable power supply is also considered as being possible, and accordingly, wired communication does not suit to the control which is characteristic of the present application.

A transmission unit of the radio communication unit 160 is controlled in such a manner that the transmission unit is activated when imaging data is to be transmitted and is not activated except when imaging data is to be transmitted. Further, a receiving unit of the radio communication unit 160 is controlled in such a manner that the receiving unit is activated when imaging data can be relayed. For this reason, the receiving unit is activated intermittently (discontinuously). Further, the receiving unit is controlled in such a manner that the receiving unit is regularly activated to be synchronized with another monitoring camera unit 100, apart from reception of imaging data. The synchronization here is operation for checking whether or not electric power of such other monitoring camera unit 100 remains or whether or not memory of such other monitoring camera unit 100 remains. Activation duration for the synchronization is shorter in comparison with that for transfer of imaging data.

When few memory of the memory 150 of a monitoring camera unit 100 remains and it is entered in a state where imaging data cannot be recorded, the control unit 110 of the corresponding monitoring camera unit 100 generates an urgent transmission request and sends the urgent transmission request to another monitoring camera unit 100. Such other monitoring camera unit 100 regularly activates its receiving unit for the synchronization. And accordingly, such other monitoring camera unit 100 may sometimes receive the urgent transmission request here. In a case where such other monitoring camera unit 100 could receive the urgent transmission request, if such other monitoring camera unit 100 can relay the imaging data by reducing an amount of the data to be relayed, such other monitoring camera unit 100 meets the request. The monitoring camera unit 100, which has sent the urgent transmission request, reduces then an amount of the imaging data to be transmitted and transmits a small volume of the data.

2. Operation According to an Embodiment

Next, operation of the monitoring camera unit 100 according to the present embodiment will be explained.

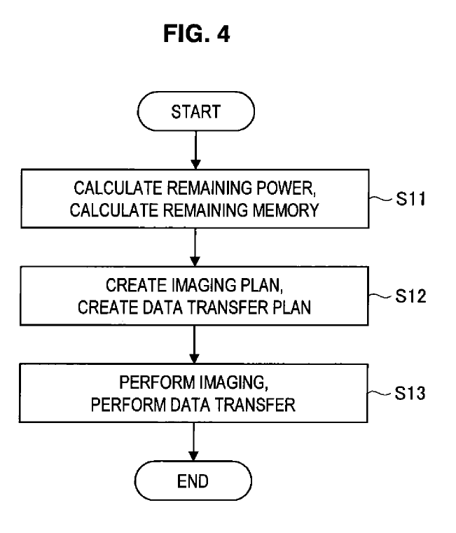

FIG. 4 is a flow chart illustrating imaging process and data transfer process of the monitoring camera unit 100 according to the present embodiment.

First, the remaining power calculation unit 112 calculates a remaining amount of electric power and the remaining memory calculation unit 114 calculates a remaining amount of memory (step S11). Then, the planning unit 120 creates an imaging plan and a data transfer plan, by referring to a charge amount in the future, which is to be expected, and comparing a currently remaining amount of electric power of the battery 130 with a remaining amount of memory of the memory 150 (step S12). After that, imaging and data transfer are carried out based on the created imaging plan and the created data transfer plan, respectively (step S13).

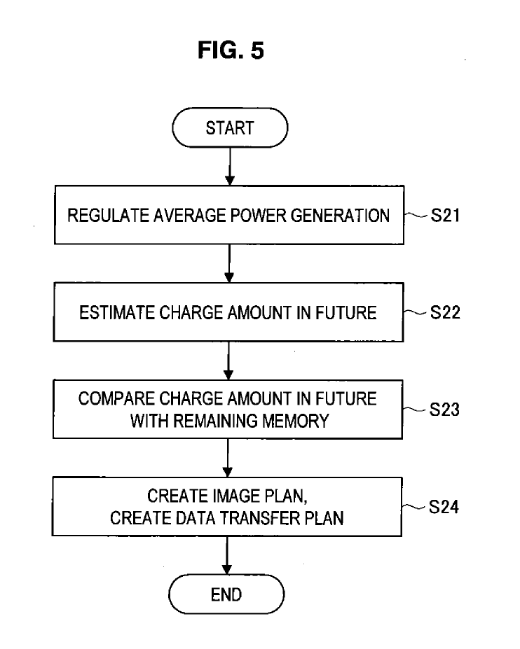

FIG. 5 is a flow chart illustrating imaging planning process and data transfer planning process of the monitoring camera unit 100 according to the present embodiment.

First, the average power generation regulation unit 116 acquires power generation data such as an actual amount of electric power generated by the photovoltaic power generation panel 102 and a generation amount of electric power calculated from sunshine duration data. Then, the average power generation regulation unit 116 regulates average power generation in units of days or hours, based on the power generation data (step S21). Next, the charge amount estimation unit 118 calculates a charge amount in the future based on the average power generation (step S22). Then, the planning unit 120 refers to the charge amount in the future, which is expected, and compares a currently remaining amount of electric power of the battery 130 with a remaining amount of memory of the memory 150 (step S23). As a result, an imaging plan and a data transfer plan are created by the planning unit 120 (step S24).

Hereafter, an example of an imaging plan and a data transfer plan, which are created, will be explained.

Here, explanation will be made by taking a monitoring camera unit 100 having the photovoltaic power generation panel 102 as an example. Electric power is generated in the daytime and is not generated at night, because it relates to the photovoltaic power generation.

Provided that an amount E of electric power is to be consumed in a day by all circuits provided in a monitoring camera unit 100, approximately an amount 2E of electric power, for example, is needed for total capacity of the battery 13. And it is desirable that the photovoltaic power generation panel 102 can generate approximately an amount E of electric power in a day except the case where it rains. Further, with respect to the memory 150, provided that an amount M of memory is needed to save imaging data for a day, it is enough to provide the memory 150 with approximately an amount 4M of total capacity, for example. Besides, it is possible to increase surplus power of the monitoring camera unit 100 by producing the photovoltaic power generation panel 102, the battery 130, and the memory 150 larger, but there arises an issue that it costs a lot. Accordingly, the size described above is an example of an adequate size.

Here, it is assumed that, when it rains for two days, an amount of electric power of the battery 130 is reduced to an amount E/2 at night of the second day. In this case, electric power will run short in another half-day, and accordingly, an imaging plan or a data transfer plan is changed in such a manner that power consumption is suppressed. For example, imaging may be performed after an imaging time interval has been expanded or a rotation angle interval at the time of capturing an image has been expanded.

It is desirable that imaging data is transferred around the time when a remaining amount of memory of the memory 150 becomes to be less than or equal to an amount M. However, the memory 150 of a destination monitoring camera unit 100 has only an amount 4M of capacity, and accordingly, it is difficult to transmit thereto more than an amount 2M of data. Accordingly, imaging data should be transmitted in the daytime, after each accumulation of the imaging data for a day. There is sufficient electric power in the daytime and it is highly possible that imaging data can be transmitted. In case imaging data cannot be transmitted due to bad weather, transmission process is postponed until the next day. The transmission process may be postponed for up to four days. When an amount 3M of data has been stored, the imaging data is to be urgently transferred little by little (by an amount of M/2, for example).

Further, when electric power of the battery 130 becomes so insufficient that the corresponding monitoring camera unit 100 cannot operate, the frequency of the synchronization is also to be decreased.

As described above, it becomes possible to perform flexible imaging or flexible data transfer depending on a charge amount of the battery 130, by creating an imaging plan or a data transfer plan.

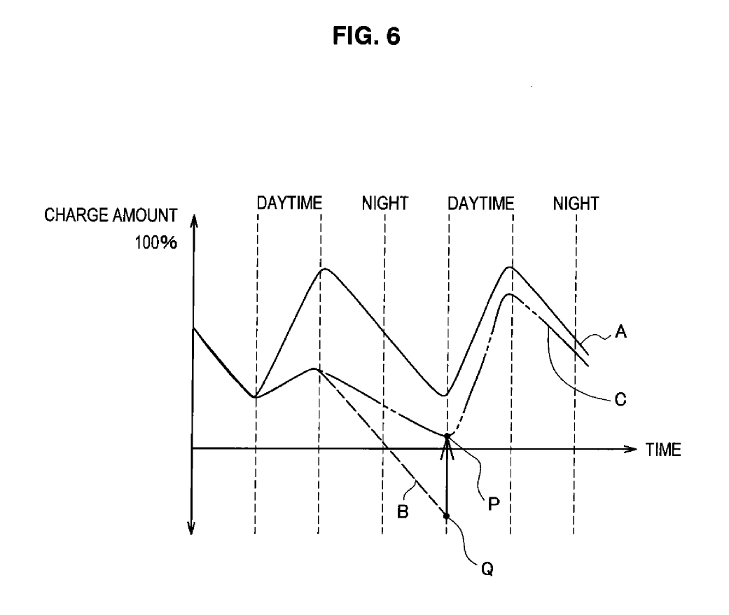

Furthermore, a variation in a charge amount will be explained with reference to FIG. 6, apart from the above example. FIG. 6 is a graph illustrating a variation in a charge amount over time.

When power generation is reliably performed in fine weather and the battery 130 is charged with electric power, a charge amount increases in the daytime and decreases at night due to imaging or data transfer, as indicated by A of FIG. 6. The same charge/discharge of electric power is repeated also the next day.

However, in a case where power generation is not performed due to rainy weather, when imaging or data transfer is performed as in fine weather, there is a possibility that remaining electric power may run short in near future, as indicated by B of FIG. 6. Accordingly, the image quality of imaging data, an imaging time interval, an imaging range, frequency of data transfer, or the like is regulated. Further, an imaging plan or a data transfer plan is created in such a manner that a charge amount in rainy weather decreases to an amount P, not to zero, even though the charge amount may fall to an amount Q when imaging or data transfer is performed in the same pace as in fine weather, so that the charge amount changes as indicated by C of FIG. 6.

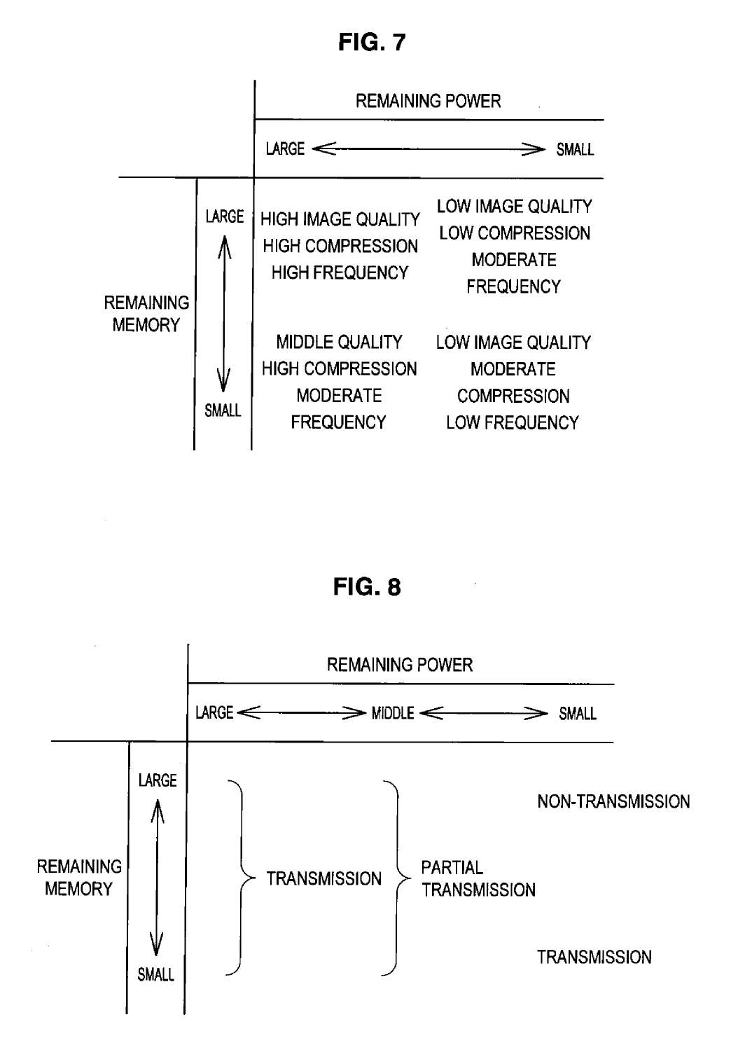

Next, a method of deciding, in imaging planning, on the image quality of imaging data, a compression rate, and an imaging time interval, and a method of deciding, in data transfer planning, on an amount of imaging data to be transferred will be explained with reference to FIGS. 7 and 8. FIG. 7 is a table illustrating an example of a method of deciding on an image plan. FIG. 8 is a table illustrating an example of a method of deciding on a data transfer plan.

For example, as shown in FIG. 7, when much electric power as well as much memory remain, high compression and high quality imaging data is generated and imaging is performed at high frequency. When little electric power and much memory remain, low compression and low quality imaging data is generated and imaging is performed at moderate frequency. When much electric power and little memory remain, high compression and middle quality imaging data is generated and imaging is performed at moderate frequency. When little electric power as well as little memory remain, moderate compression and low quality image data is generated and imaging is performed at low frequency.

Further, as shown in FIG. 8, when much electric power remains, imaging data is transmitted regardless of whether remaining memory is large or small. When remaining electric power is middle level such as being little but lasting till the next day, imaging data is partially transmitted regardless of whether the remaining memory is large or small. When remaining electric power has been further decreased, in case of much remaining memory, imaging data is not transmitted; in case of little remaining memory, imaging data is transmitted. Thereby, it makes it possible to continuously perform imaging, though little memory remains.

As described above, according to the present embodiment, it is possible to estimate a charge amount in the future based on average power generation, without receiving information such as weather information. Further, in the present embodiment, power consumption of the battery 130 is reduced, or a remaining amount of memory of the memory 150 is regulated in such a manner that imaging data can be recorded therein. For this reason, in the present embodiment, it is possible to continuously perform imaging regardless of a remaining amount of electric power of the battery 130 or a remaining amount of memory of the memory 150, without monitoring being stopped.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An imaging apparatus comprising:
a power generation unit which converts natural energy into electric energy and generates electric power;
an imaging unit which captures a subject image and generates imaging data;
a memory which stores the imaging data;
a radio communication unit which transmits the imaging data stored in the memory;
a control unit which controls operation of the imaging unit and of the radio communication unit; and
a battery which is charged with the generated electric energy and supplies electric power to the imaging unit, the memory, the radio communication unit, and the control unit,
wherein the control unit estimates a charge amount of the battery in the future based on average power generation of the power generation unit and changes operation of the imaging unit or of the radio communication unit, based on the charge amount in the future.

2. The imaging apparatus according to claim 1,
wherein the control unit calculates a remaining amount of memory of the memory and calculates a remaining amount of electric power of the battery and changes operation of the imaging unit or of the radio communication unit, based on the remaining amount of memory and the remaining amount of electric power, which were calculated.

3. The imaging apparatus according to claim 1,
wherein the control unit changes operation of the imaging unit by controlling image quality of the imaging data, a compression rate of the imaging data, and imaging frequency or an imaging range of the imaging unit.

4. The imaging apparatus according to claim 1,
wherein the control unit changes operation of the radio communication unit by controlling transmission frequency of the imaging data.

5. The imaging apparatus according to claim 1,
wherein the control unit causes the radio communication unit to receive imaging data from an external imaging apparatus and to transmit the received imaging data to another external imaging apparatus, based on the charge amount in the future.

6. A method of controlling an imaging apparatus, comprising the steps of:
converting by a power generation unit natural energy into electric energy and generating by the power generation unit electric power;
capturing by an imaging unit a subject image and generating by the imaging unit imaging data;
storing by a memory the imaging data;
transmitting by a radio communication unit the imaging data stored in the memory;
controlling by a control unit operation of the imaging unit and of the radio communication unit;
charging by a battery the generated electric energy and supplying by the battery electric power to the imaging unit, the memory, the radio communication unit, and the control unit, and
estimating by the control unit a charge amount of the battery in the future based on average power generation of the power generation unit and changing by the control unit operation of the imaging unit or of the radio communication unit, based on the charge amount in the future.
